(19) United States
(12) Patent Application Publication
(10) Pub. No.: US 2016/0130396 A1
(43) Pub. Date: May 12, 2016

(54) Polyoxazoline Chelating Agent

(71) Applicant: BASF SE, Ludwigshafen (DE)

(72) Inventors: Jeremy T. Manning, Brownstown, MI (US); Jon A. Debling, Saline, MI (US)

(21) Appl. No.: 14/768,536

(22) PCT Filed: Mar. 11, 2014
(86) PCT No.: PCT/US2014/023462

§ 371 Date: Aug. 18, 2015

Related U.S. Application Data
(60) Provisional application No. 61/798,999, filed on Mar. 15, 2013.

(51) Int. Cl. C08G 69/00; C08L 77/00

(52) U.S. Cl. CPC C08G 69/00; C08L 77/00; C08L 2201/54

(57) ABSTRACT

A chelating agent comprises a polyoxazoline. The polyoxazoline has formula A: (formula A), where R is H; F; CI; Br; I; CN; NO₂; an organic group having from 1 to 20 carbon atoms; an amino group; or an oxazoline, and n is from about 2 to about 300. The polyoxazoline also has a weight average molecular weight of from about 1,500 to about 30,000.

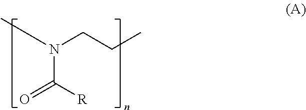

### CROSS REFERENCE TO RELATED APPLICATIONS

This application claims priority to and all the benefits of U.S. Provisional Patent Application Ser. No. 61/798,999, filed on Mar. 15, 2013, the contents of which are expressly incorporated herein by reference.

### FIELD OF THE DISCLOSURE

The present disclosure generally relates to a chelating agent. More specifically, the present disclosure relates to a chelating agent comprising polyoxazoline.

### BACKGROUND

Chelation is the formation of coordinate bonds between a chemical compound and a central atom, such as a metal ion, to form a complex known as a chelate. The chemical compound is often referred to as a chelating agent, but is also known by other names such as a chelant, a chelator, or a sequestering agent. In an example, the chelating agent can be an organic ligand that has a chemical affinity for the central atom.

The chelate formed during chelation may be used, for instance, to trap and remove heavy metal ions from an environment. Some chelates are naturally-occurring, such as those that transport nutrients through living organisms including plants and animals. Other chelates are synthetic or man-made, such as ethylenediamine-N,N,N′,N′-tetraacetic acid (EDTA) which is often found in agricultural formulations including fertilizers.

However, many chelating agents that are currently available are most effective at a pH of about 10 or more, and such chelating agents may, in some instances, require a pH below 3 to effectively release the central atom.

Furthermore, without being bound by any theory, it is believed that polyoxazolines having a high weight average molecular weight (e.g. above 40,000) cannot effectively occupy all of the metal ion's bonding sites due, at least in part, to the relatively large size of the polyoxazoline. For at least this reasoning, it is further believed that polyoxazolines having a high weight average molecular weight cannot suitably sequester a metal ion.

### SUMMARY OF THE DISCLOSURE AND ADVANTAGES

The present disclosure provides a chelating agent comprising a polyoxazoline. The polyoxazoline has formula A:

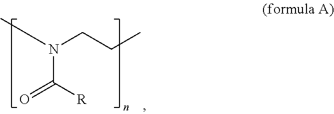

where R is H; F; Cl; Br; I; CN; NO₂; an organic group having from 1 to 20 carbon atoms selected from an alkyl group, an alkenyl group, an aryl group, a heteroaryl group, or a heterocyclyl group; an amino group; or an oxazoline, and n is from about 2 to about 300. The polyoxazoline has a weight average molecular weight of from about 1,500 to about 30,000.

The chelating agent effectively bonds to a metal ion at a pH of from 6 to 8, rendering the chelating agent as being most effective in neutral environments, i.e., those having a pH of from 6 to 8. The chelating agent suitably sequesters the metal ion in, for example, the neutral environment so that the metal ion cannot interact (e.g. react) with other components present in the neutral environment. Such is unlike other known chelating agents that are used for the chelation of metal ions, which typically bond to metal ions at a higher pH, e.g. at a pH of about 10 or higher. Furthermore, the chelating agent of the present disclosure releases a metal ion when the pH drops to a value below 6. Such is also unlike known chelating agents, where an excess of positive nucleophiles (H⁺ ions) are often required to break chelation bonds of these chelating agents. Accordingly, a pH of less than 3 is often required in order to release the metal ion. Release of the metal ion is beneficial, for example, for recovery of the metal ion so that the metal ion can be reused. Such is particularly beneficial for the recovery and reuse of precious metals.

### BRIEF DESCRIPTION OF THE DRAWING

Other advantages of the present disclosure will be readily appreciated, as the same becomes better understood by reference to the following detailed description when considered in connection with the accompanying drawing.

FIG. 1 is a graph showing the relationship between a measured chelation value of various chelating agents and pH.

### DETAILED DESCRIPTION OF THE PRESENT DISCLOSURE

The chelating agent of the present disclosure is used for the chelation of metal ions from various environments. The chelating agent may be used in any metal-infused, water-based environment. In some instances, the chelating agent may be used in paper mills during paper bleaching, for example. It is believed that the chelating agent is also usable to sequester precious metals, such those having a 2⁺ or 3⁺ valency.

Examples of the chelating agent, as disclosed herein, comprise a polyoxazoline having formula A:

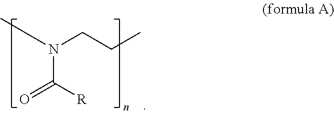

In formula A, R is H; F; Cl; Br; I; CN; NO₂; an organic group having from 1 to 20 carbon atoms selected from an alkyl group, an alkenyl group, an aryl group, a heteroaryl group, or a heterocyclyl group; an amino group; or an oxazoline. In an example, R is an alkyl group having from 1 to 20 carbon atoms. In another example, R is an alkyl group having from 1 to 8 carbon atoms. In still another example, R is an alkyl group having from 1 to 4 carbon atoms. Specific examples of R groups for the polyoxazoline include, but are not limited to, methyl, ethyl, and propyl groups.

It is to be understood alkyl groups may include straight chain and branched alkyl groups having from 1 to 20 carbon atoms.

Also in formula A, in an example, n is from about 2 to about 300. In another example, n is from about 2 to about 240. In yet another example, n is from about 6 to about 100. It is to be understood, however, that the value of n depends, at least in part, on the weight average molecular weight and the number average molecular weight of the polyoxazoline. For purposes of illustration, examples of the value of n are set forth below when R in formula A is an ethyl group. In one example, n is from about 7 to about 152 and the polyoxazoline has a weight average molecular weight of from about 1,500 to about 30,000 and a number average molecular weight of from about 750 to about 15,000. In still another example, n is from about 25 to about 102 and the polyoxazoline has a weight average molecular weight of from about 5,000 to about 20,000 and a number average molecular weight of from about 2,500 to about 10,000. In a further example, n is from about 50 to about 91 and the polyoxazoline has a weight average molecular weight of from about 10,000 to about 18,000 and a number average molecular weight of from about 5,000 to about 9,000.

In another example, the value of n, when R in formula A is H, is from about 10 to about 212 and the weight average molecular weight of the polyoxazoline is from about 1,500 to about 30,000 and the number average molecular weight is from about 750 to about 15,000. In still another example, the value of n, when R in formula A is an alkyl group having 20 carbon atoms, is from about 2 to about 43 and the weight average molecular weight of the polyoxazoline is from about 1,500 to about 30,000 and the number average molecular weight is from about 750 to about 15,000.

The following formula, formula B, illustrates the example where R is the ethyl group:

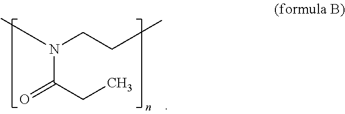

In formula B, assuming the weight average molecular weight of the polyoxazoline is from about 10,000 to about 18,000 (as above), then n is from about 50 to about 91. Some examples of the polyoxazoline are poly-2-methyloxazoline, poly-2-ethyl-2-oxazoline, and poly-2-isopropyl-2-oxazoline. In one example, the polyoxazoline is poly-2-ethyl-2-oxazoline.

In an example, and as previously mentioned, the polyoxazoline of the present disclosure has a weight average molecular weight of from about 1,500 to about 30,000. In another example, the polyoxazoline has a weight average molecular weight of from about 5,000 to about 20,000. In a further example, the polyoxazoline has a weight average molecular weight of from about 10,000 to about 18,000. In yet a further example, the polyoxazoline has a weight average molecular weight of from about 1,000 to about 40,000. In still another example, the polyoxazoline has a weight average molecular weight of about 14,000. Without being bound to any theory, it is believed that a polyoxazoline (e.g. poly-2-ethyl-2-oxazoline) having a weight average molecular weight of from about 1,500 to about 30,000 renders the polyoxazoline small enough to suitably wrap itself around and bond to a metal ion so long as the pH of the chelating agent is from about 6 to about 8. The polyoxazoline (e.g. poly-2-ethyl-2-oxazoline) is also small enough to suitably release the metal ion when the pH of the chelating agent falls below 6.

It is to be understood that the weight average molecular weight of the polyoxazoline for the chelating agent of the present disclosure is lower than that of other polyoxazolines. It has unexpectedly and fortuitously been found that the polyoxazoline having a weight average molecular weight of from about 1,500 to about 30,000 has a relatively high chelation value at a pH of from about 6 to about 8. For example, poly-2-ethyl-2-oxazoline having a weight average molecular weight of from about 10,000 to about 18,000 has a chelation value of from about 300 mg of CaCO₃/g of chelating agent (i.e., 300 mg of CaCO₃ per gram of chelating agent) to about 800 mg of CaCO₃/g of chelating agent (measured according to the American Association of Textile Chemists and Colorists (AATCC) Test Method 149-2007) at a pH of the chelating agent (which includes the poly-2-ethyl-2-oxazoline and water) of from about 6 to about 8. The AATCC Test Method 149-2007 is a standardized test method for determining the chelation value of aminopolycarbonate acids and their salts. Details of the AATCC Test Method 149-2007 are provided in the Examples set forth below. In another example, poly-2-ethyl-2-oxazoline (again which has a weight average molecular weight of from about 10,000 to about 18,000) has a chelation value of from about 500 mg of CaCO₃/g of chelating agent to about 800 mg of CaCO₃/g of chelating agent at a pH of the chelating agent (which includes the poly-2-ethyl-2-oxazoline and water) of from about 6 to about 8. This is in contrast to polyoxazolines having a high weight average molecular weight (e.g. a weight average molecular weight of 50,000 or higher) and other known chelating agents, which have very low chelation values if any at all.

Although not required, the examples of the polyoxazoline as presently disclosed are typically combined with water. In some instances, the polyoxazoline is obtained in solid form, such as a powder, and is thereafter added to or otherwise incorporated into a system that contains water. In some instances, the polyoxazoline is combined with water, and the combination of polyoxazoline and water is then added to or otherwise incorporated into the system. In any event, to properly function as a chelating agent, polyoxazoline is combined with water. In an example, the polyoxazoline is present in the chelating agent in an amount of from about 35 wt % to about 45 wt % of the total wt % of the chelating agent, and the water is present in an amount of from about 55 wt % to about 65 wt %. In another example, about 40 wt % of the polyoxazoline is present in the chelating agent, and about 60 wt % of water is present in the chelating agent. It is believed that a lower amount of water may be used for easier control of the pH of the chelating agent.

In an example, the polyoxazoline having a weight average molecular weight of from about 1,500 to about 30,000 is formed utilizing a continuous polymerization process performed in a reactor at an elevated temperature. Such is in contrast to polyoxazolines having a higher weight average molecular weight, which are typically made using batch or semi-batch polymerization processes. Examples of the continuous polymerization process performed in a reactor at an elevated temperature are described in detail below in conjunction with a method of making the chelating agent.

When the chelating agent includes water, a method of making the examples of the chelating agent generally comprises preparing the polyoxazoline, and mixing the polyoxazoline with water. Details of the method are set forth below. Additionally, details of the method are described in co-pending U.S. Provisional Patent Application Ser. No. 61/793,738, filed on Mar. 15, 2013, and U.S. Non-Provisional patent application Ser. No. ______, filed on ______, which claims priority to U.S. Provisional Application Ser. No. 61/793,738. The contents of each of U.S. Provisional Patent Application Ser. No. 61/793,738 and U.S. Non-Provisional patent application Ser. No. ______ are herein incorporated by reference in their entirety.

The polyoxazoline is prepared by continuously polymerizing an oxazoline monomer in a reactor at an elevated temperature. During the process of continuously polymerizing (which may be referred to herein as a continuous polymerization process), the oxazoline monomer is continuously fed into a reactor. Continuous polymerization processes are often described as living polymerization processes, where the oxazoline monomer is polymerized until the monomer is gone. Continuous polymerization at an elevated temperature typically describes the continuous polymerization of the oxazoline monomer in the reactor at a temperature of at least 150° C. In another example, continuous polymerization at an elevated temperature describes the continuous polymerization of the oxazoline monomer in the reactor at a temperature of from about 150° C. to about 250° C. In still another example, continuous polymerization as an elevated temperature describes the continuous polymerization of the oxazoline monomer in the reactor at a temperature of from about 180° C. to about 220° C. In one particular example, continuous polymerization at an elevated temperature describes the continuous polymerization of the oxazoline monomer in the reactor at a temperature of about 200° C.

The oxazoline monomer is continuously fed into the reactor. In an example, a single oxazoline monomer is fed into the reactor. Alternatively, and as another example, a combination of two or more oxazoline monomers are fed into the reactor. Combinations of two or more oxazoline monomers may generally be used to form polyoxazolines having a wide range of solubilities, glass transition temperatures (T_{g}), and/or other similar properties. In instances where two or more oxazoline monomers are fed into the reactor, the monomers may be fed together into a single reactor. Alternatively, multiple reactors in sequence may be used for the continuous polymerization of multiple oxazoline monomers. For instance, a first oxazoline monomer may be fed into a first reactor, a second monomer may then be fed into a second reactor, and so on. Polymerization of the first oxazoline monomer progresses until the first oxazoline monomer is gone, and polymerization resumes upon addition of the second oxazoline monomer. Where different oxazoline monomers are used, the polymerization of the oxazoline monomers may result in blocks of the polymer of each oxazoline monomer that is added to the reactor, thereby forming block polyoxazolines. The degree of polymerization, and hence the weight average molecular weight, is controlled by the monomer and catalyst, solvent, and other factors typical to polymerization as an initiator concentration. This allows for the synthesis of well-defined species with a narrow molecular weight distribution, as well as block polymers with controlled block lengths.

Examples of the reactor that may be used in the method disclosed herein include continuous stirred tank reactors (CSTRs), loop reactors, extruders, and other reactors that are configured for continuous polymerization processes. In one example, the reactor comprises a CSTR. In one example, a single reactor may be used to perform the polymerization of the oxazoline monomer. In another example, two or more reactors may be used to perform the polymerization of the oxazoline monomer. In the latter example, the reactors may be used in series, such as two, three, etc. CSTRs in series. In one example, the reactor comprises a series of reactors comprising at least one CSTR.

The oxazoline monomer and a catalyst are fed continuously into the reactor at a rate to i) enable ring-opening of the oxazoline monomer and ii) polymerize the oxazoline monomer. The oxazoline monomer and the catalyst are continuously fed to the reactor at a rate that provides for a residence time sufficient to achieve ring opening of the oxazoline monomer to polymerize the oxazoline monomer. In other words, the rate at which the oxazoline monomer and the catalyst is fed into the reactor depends, at least in part, on the residence time of the oxazoline monomer inside the reactor in order to achieve the ring-opening and the polymerization of the oxazoline monomer. To achieve the residence time, the feed rate of the oxazoline monomer may be varied. In an example, the residence time of the oxazoline monomer inside the reactor ranges from about 1 minute to about 60 minutes. In another example, the residence time of the oxazoline monomer inside the reactor ranges from about 1 minute to about 30 minutes. In yet another example, the residence time of the oxazoline monomer inside the reactor ranges from about 5 minutes to about 15 minutes.

In an example, the reactor is heated as the oxazoline monomer and the catalyst are fed continuously into the reactor. The temperature at which the reactor is heated is also the temperature at which polymerization of the oxazoline monomer occurs. In an example, the reactor is maintained (during feeding and polymerization) at a temperature of from about 150° C. to about 250° C. In another example, the reactor is maintained at a temperature of from about 180° C. to about 220° C. In one particular example, the reactor s maintained at a temperature of about 200° C.

The oxazoline monomer fed continuously into the reactor is a substituted 2-oxazoline having a structure represented by formula C:

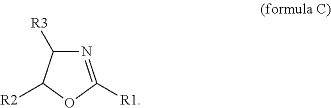

In formula C, R1 is H; F; Cl; Br; I; CN; NO₂; an organic group having from 1 to 20 carbon atoms selected from an alkyl group, an alkenyl group, an aryl group, a heteroaryl group, or a heterocyclyl group; an amino group; or an oxazoline. In one example, R1 is an alkyl group having from 1 to 20 carbon atoms. In another example, R1 is an alkyl group having from 1 to 3 carbon atoms. In other examples, R1 is an alkenyl group having from 1 to 20 carbon atoms. In yet other examples, R1 is an aryl group having from 6 to 18 carbon atoms. In still another example, R1 is an oxazoline. Furthermore, R2 and R3 are individually H; F; Cl; Br; I; CN; NO₂; an organic group having from 1 to 20 carbon atoms selected from an alkyl group, an alkenyl group, an aryl group, a heteroaryl group, or a heterocyclyl group; or an amino group. In an example, R2 and R3 are individually selected from H, a methyl group, and a phenyl group. Suitable examples of the oxazoline monomer include, but are not limited to, 2-methyl-2-oxazoline, 2-ethyl-2-oxazoline, 2-propyl-2-oxazoline, 2-isopropyl-2-oxazoline, and combinations thereof. In an example, the oxazoline monomer can be an oxazoline macromonomer. Further, it is believed that copolymers, such as block, graft, star-shaped, and branched oxazoline copolymers, and acrylate-oxazoline copolymers, may be used in conjunction with the oxazoline monomer. As noted above, any two or more of such oxazoline monomers may be used to prepare the polyoxazoline.

It is to be understood that the definition for R in formula A and R1 in formula C are the same.

The oxazoline monomer may be synthesized utilizing a number of known methods. One example of the synthesis of the oxazoline monomer is shown in the reaction synthesis (1) set forth below:

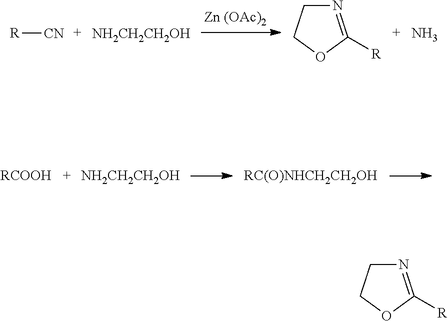

The catalyst is selected from any catalyst that will suitably and effectively catalyze the polymerization of the oxazoline monomer inside the reactor. Examples of the catalyst include strong electrophiles. Other examples of catalysts include weak Lewis acids, strong protic acids, alkyl halides, benzyl halides, substituted benzyl halides, strong acid esters, and combinations thereof. In an example, the catalyst is a weak Lewis acid, an alkyl halide, a strong acid ester, or a mixture of any two or more thereof. The catalyst may be, for instance, methyl-p-toluene sulfonate, methyl-p-toluene sulfonic acid (MSA), bismuth salts (such as BiCl₃, BiBr₃, BiI₃, and bismuth triflate), benzyl chloride, benzyl iodide, and benzyl bromide. In one example, the catalyst is methyl-p-toluene sulfonic acid or a salt thereof. Further, the total amount of catalyst to be fed to the reactor is based, at least in part, on the amount of oxazoline monomer that is fed to the reactor.

The amount of catalyst used is based, for example, on a molar ratio of catalyst to oxazoline monomer to obtain i) a suitable rate of reaction in the reactor and ii) desirable weight average molecular weight of the polyoxazoline. In some examples, the molar ratio of catalyst:oxazoline monomer is from about 1:25 to about 1:400. In other examples, the molar ratio of catalyst:oxazoline monomer is from about 1:85 to about 1:150. In one specific example, the molar ratio of catalyst:oxazoline monomer is about 1:100. Additionally, the catalyst may be present in an amount of from about 1 wt % to about 2 wt % based on the total wt % of the oxazoline monomer present in the mixture. In another example, the catalyst is present in an amount of from about wt % to about 2 wt % based on the total wt % of the oxazoline monomer present in the mixture.

In some instances, the method further comprises feeding a solvent to the reactor with the oxazoline monomer and the catalyst. In one example, the oxazoline monomer, the catalyst, and the solvent are continuously fed into the reactor individually in three separate streams. In another example, the oxazoline monomer, the catalyst, and the solvent are fed together in a single stream. In still another example, the oxazoline monomer and the catalyst may be combined and fed together in one stream, while the solvent is fed into the reactor in a separate stream. Still further, the oxazoline monomer may be combined with the solvent, and both may be continuously fed into the reactor in a single stream while the catalyst alone is continuously fed into the reactor in another stream.

The solvent, if used, serves as a medium within which the oxazoline monomer polymerizes. The solvent also dissolves the oxazoline monomer for efficient polymerization and may solubilize or suspend the catalyst and polyoxazolines that are formed. In instances where the oxazoline monomer and the solvent are fed into the reactor in the same flow stream, the oxazoline monomer is dissolved in the solvent prior to being fed into the reactor. In instances where the oxazoline monomer and the solvent are fed into the reactor in separate flow streams, the oxazoline monomer is dissolved in the solvent inside the reactor. Additionally, the oxazoline monomer and the catalyst may be dissolved in the solvent prior to feeding if all three components are present.

Examples of solvents that may be used include hydrocarbons (e.g. aromatic compounds), esters, ethers, ketones, polar aprotic solvents, and combinations thereof. In one example, the solvent is a polar aprotic solvent, an ester, an ether, a ketone, or an aromatic solvent. Some specific examples of solvents include methyl amyl ketone (MAK), methyl iso-butyl ketone, acetone, methyl ethyl ketone, xylene, Aromatic 100 and 150 (Colonial Chemical Solutions, Inc., Savannah, Ga.). The total amount of solvent that is fed or added to the reactor, for example, is from greater than 0 wt % to about 50 wt % of all of the components fed to the reactor. In some instances, the solvent may be present in an amount that is greater than 50 wt % of all of the components fed to the reactor.

In an example, the oxazoline monomer, the solvent, and/or the catalyst may be purified to remove residual chain terminators, such as water. This step may be performed inline continuously or in a separate batch step.

In the method, selection of the appropriate oxazoline monomer, operating temperatures, residence time and molar ratio of the catalyst to oxazoline monomer may result in a desired polyoxazoline and molecular weight. Normally, a higher molar ratio of the monomer to catalyst will lead to a higher molecular weight of the polyoxazoline. In addition, an increase in the residence time of the oxazoline monomer inside the reactor tends to increase the molecular weight of the polyoxazoline at equal molar ratios of the oxazoline monomer to catalyst. However, the molecular weight is dependent, at least in part, on the mode of termination of living chains of the polyoxazoline. In addition, the nature of the reactor's configuration and, thus, residence time distribution has an effect on the molecular weight and molecular weight distribution of the polyoxazoline. Furthermore, fully backmixed processes, such as those that utilize a CSTR, tend to produce polyoxazolines with broader molecular weight distributions. For example, higher ratios of oxazoline monomer to catalyst in the feed stream may produce higher molecular weight polyoxazolines. Alternatively, lower ratios of oxazoline monomer to catalyst may produce lower molecular weight polyoxazolines.

Inside the reactor, polymerization of the oxazoline monomer is accomplished, for example, by cationic ring-opening polymerization (CROP). Cationic ring-opening polymerization is a polymerization technique that includes ring-opening of a cyclic compound (e.g. the oxazoline monomer) to form a polymer. The ling-opening reaction is generally accelerated by the catalyst.

In an example, the cationic ring-opening polymerization of the oxazoline monomer occurs at a high or elevated temperature (e.g. from 150° C. to 250° C.).

It is believed that variable end groups of the polyoxazoline are formed during ring-opening polymerization by the random ring-opening of the oxazoline monomer along with the elevated polymerization temperature. For instance, when the oxazoline monomer is 2-ethyl-2-oxazoline, the poly-2-ethyl-2-oxazoline formed during polymerization may include H end groups, CH₃ end groups, ring-closed oxazoline end groups, and/or ring-opened end groups of the oxazoline monomer. During further polymerization, various repeat units may be incorporated into the backbone of the polyoxazoline due, at least in part, to the various end groups mentioned above.

It is to be understood that the molecular weight of the polyoxazoline depends, at least in part, on the temperature of the reactor and the amount of catalyst during the continuous polymerization. Any of the temperature and the amount of catalyst may be controlled, for example, to control the molecular weight of the resultant polyoxazoline.

The method further comprises exiting a polyoxazoline solution from the reactor, where the polyoxazoline solution comprises the catalyst or catalyst fragments and, optionally, unreacted oxazoline monomer, oligomeric species of the oxazoline monomer, or a mixture thereof. The oligomeric species of the oxazoline monomer have a low weight average molecular weight. In an example, the weight average molecular weight of the oligomeric species is considered to be low when the weight average molecular weight is less than 1,500. In another example, the weight average molecular weight of the oligomeric species is considered to be low when the weight average molecular weight is less than 1,000. The polyoxazoline is continuously removed from the reactor as the polyoxazoline is formed. The polyoxazoline may be isolated or separated from the polyoxazoline solution, and may be recovered upon removing the other solution components.

The polyoxazoline may be separated from the other solution components after the polyoxazoline has been removed from the reactor. In one example, separation of the polyoxazoline from the other solution components is accomplished by exposing all of the components removed from the reactor to a vacuum to evaporate all of the liquid-based components. In one example, the solvent is removed. In another example, all of the liquid-based components are removed in addition to the solvent. The components remaining are solid components that include the polyoxazoline. In an example, the yield of the polyoxazoline is greater than 90%. In another example, the yield of the polyoxazoline is greater than 95%. It is to be understood that the yield of polyoxazoline may be adjusted by adjusting the amount of oxazoline monomer fed to the reactor. In some instances, the yield of polyoxazoline may be adjusted to be about 100%.

In an example, the recovered polyoxazoline may then be combined (e.g. mixed) with water to form the chelating agent.

The chelating agent may be used in a method for deactivating a metal ion. In an example, deactivation of metal ions may be used to inhibit catalytic effects of the metal ion when the metal ion is exposed to certain environments. An example of a method for deactivating a metal ion comprises preparing the chelating agent, and introducing the chelating agent into a system including the metal ion (e.g. where metal ions are present). The chelating agent complexes with and deactivates the metal ion.

It is to be understood that the chelating agent may be prepared utilizing any of the examples described above. In some instances, the pH of the chelating agent may be adjusted so that the pH of the chelating agent ranges from about 6 to about 8. Adjusting of the pH may be accomplished, for example, by adding a pH buffer to the chelating agent. Thereafter, the chelating agent is introduced into the system including the metal ion. In one example, the chelating agent alone is added to the system including the metal ion. In another example, the chelating agent is added to a composition, and then the composition including the chelating agent is added to the system including the metal ion.

To further illustrate examples of the present disclosure, the following Examples are given herein. It is to be understood that the Examples are provided for illustrative purposes and are not to be construed as limiting the scope of the present disclosure.

### EXAMPLES

A chelating agent is prepared that includes poly-2-ethyl-2-oxazoline and water, and is referred to as Example 1. The poly-2-ethyl-oxazoline of Example 1 is prepared by cationic ring-opening polymerization in a CSTR at a temperature of about 200° C. Specifically, about 41.7 wt % ethyl oxazoline, about 36.3 wt % methyl amyl ketone, and about 1.2 wt % methyl-p-toluene sulfonate are mixed in a vessel until a clear solution is obtained. The molar ratio of ethyl oxazoline monomer to methyl-p-toluene sulfonate is 99.6. The clear solution is then continuously fed or introduced into a 100 mL CSTR at a rate sufficient to maintain a 12 minute residence time in the CSTR. Poly-2-ethyl-2-oxazoline formed in the CSTR is continuously removed from the CSTR and is subjected to a vacuum to remove the liquid-based components and excess ethyl oxazoline monomer. The components removed are then condensed and recovered. After a steady state is achieved, the poly-2-ethyl-2-oxazoline is collected and analyzed. The poly-2-ethyl-2-oxazoline collected has a weight average molecular weight of about 14,000.

Gas chromatography is performed on the recovered liquid-based components and excess ethyl oxazoline monomer to determine to determine the amount of liquid-based components and excess ethyl oxazoline monomer. Utilizing mass balance equations, the amount of ethyl oxazoline monomer converted to the poly-2-ethyl-2-oxazoline is computed. In this example, a total conversion of over 90% of the ethyl oxazoline monomer to the poly-2-ethyl-2-oxazoline is achieved.

Several other chelating agents are obtained and utilized as comparative examples (Examples 2 through 5). As Example 2, the comparative chelating agent includes a polyoxazoline having a weight average molecular weight of about 50,000 (polyoxazoline commercially available from Sigma Aldrich). As Example 3, the comparative chelating agent includes a tetrasodium salt of EDTA (Trilon® B commercially available from BASF Corporation). As Example 4, the comparative chelating agent includes diammonium EDTA (Trilon® BAD commercially available from BASF Corporation). As Example 5, the comparative chelating agent is a liquid polymeric chelating agent (Trilon® P commercially available from BASF Corporation).

A chelation value for the chelating agent of Example 1 and the comparative chelating agents of Examples 2 through 5 is measured utilizing the AATCC Test Method 149-2007 mentioned above. Specifically, about 1 gram of each chelating agent is placed in a 250 mL Erlenmeyer flask, and about 100 mL of dionized water is added to the flask. Then, about 10 mL of a 1% sodium carbonate solution is added to the flask, and the pH is adjusted utilizing a NaOH solution. Then, in a lighted stir plate, a 0.1 M solution of calcium acetate is titrated until a first sign of turbidity is noticed. The amount of the calcium acetate solution (in mL) is recorded and used to calculate the mg of CaCO₃/g of chelating agent (i.e., the chelation value). The chelation values are measured (e.g. calculated) by multiplying i) the mL of the calcium acetate solution recorded, ii) the molarity of the calcium acetate solution and iii) the molar mass of the CaCO₃. This product is then divided by the product of the grams of the chelating agent and the activity of the chelant.

Table 1 sets forth the measured chelation value based on pH for the polyoxazoline (Example 1) and all of the comparative examples (Examples 2 through 5). Table 1 also sets forth the respective amounts of the sodium carbonate solution that was titrated (in mL) during the test method.

TABLE 1
Measured Chelation Value Relative to pH of Examples 1 through 5

| | | | Chelation | Chelating |
|---|---|---|---|---|
| | pH | mL titrated | Value | Agent |
| 1 | 11 | 0.68 | 16.95 | Example 1 |
| 2 | 12.5 | 0.53 | 13.2 | Example 1 |
| 3 | 12.25 | 0.5 | 12.5 | Example 1 |
| 4 | 12 | 0.5 | 12.5 | Example 1 |
| 5 | 12.7 | 0.76 | 19.05 | Example 1 |
| 6 | 12.5 | 1.5 | 15 | Example 1 |
| 7 | 12 | 2.25 | 22.5 | Example 1 |
| 8 | 12.7 | 3.5 | 35 | Example 1 |
| 9 | 9.084 | 1.51 | 36.96 | Example 1 |
| 10 | 8.579 | 15.35 | 387.58 | Example 1 |
| 11 | 8.091 | 28.66 | 695.58 | Example 1 |
| 12 | 7.589 | 38.77 | 950.29 | Example 1 |
| 13 | 6.965 | 32.02 | 800.5 | Example 1 |
| 14 | 6.577 | 40.49 | 1002.28 | Example 1 |
| 15 | 6.09 | 26.78 | 662.82 | Example 1 |
| 16 | 5.579 | 0.53 | 13.17 | Example 1 |
| 17 | 11.17 | 3.65 | 90.25 | Example 5 |
| 18 | 11.17 | 3.77 | 92.5 | Example 5 |
| 19 | 9 | 19.43 | 476.27 | Example 5 |
| 20 | 9 | 11.55 | 283.19 | Example 5 |
| 21 | 11.085 | 3 | 69.44 | Example 5 |
| 22 | 9.08 | 23 | 532.41 | Example 5 |
| 23 | 2.19 | 0.52 | 13.1 | Example 1 |
| 24 | 4.2 | 0.5 | 11.36 | Example 1 |
| 25 | 4.19 | 25 | 250 | Example 1 |
| 26 | 3.95 | 40 | 381 | Example 1 |
| 27 | 2.08 | 0.5 | 12.14 | Example 1 |
| 28 | 4.08 | 110 | 110 | Example 1 |
| 29 | 2.11 | 15 | 145.6 | Example 1 |
| 30 | 10.94 | 6.91 | 172.85 | Example 4 |
| 31 | 7.89 | 2.92 | 73.05 | Example 4 |
| 32 | 4.06 | 0.91 | 21.46 | Example 4 |
| 33 | 11 | 14 | 130.84 | Example 4 |
| 34 | 8 | 12 | 112.15 | Example 4 |
| 35 | 4.09 | 6 | 56.6 | Example 4 |
| 47 | 11.11 | 4.7 | 117 | Example 3 |
| 48 | 9.05 | 8.39 | 220.8 | Example 3 |
| 49 | 11.08 | 3.5 | 90.2 | Example 3 |
| 50 | 9.04 | 12.2 | 321.1 | Example 3 |
| 51 | 6.859 | 4 | 92.59 | Example 3 |
| 52 | 11.1 | 0.77 | 19.3 | Example 2 |
| 53 | 9 | 0.5 | 12.89 | Example 2 |
| 54 | 3.12 | 0.5 | 12.25 | Example 2 |
| 55 | 11.1 | 0.5 | 12.25 | Example 2 |
| 56 | 11.1 | 0.5 | 12.5 | Example 2 |
| 57 | 9.1 | 1.2 | 12.34 | Example 2 |
| 58 | 3 | 0.5 | 12.38 | Example 2 |
| 59 | 7.1 | 0.5 | 12.38 | Example 2 |
| 60 | 9.1 | 0.9 | 22.4 | Example 2 |
| 61 | 7 | 1.1 | 25.8 | Example 2 |
| 62 | 3.1 | 0.8 | 13.1 | Example 2 |

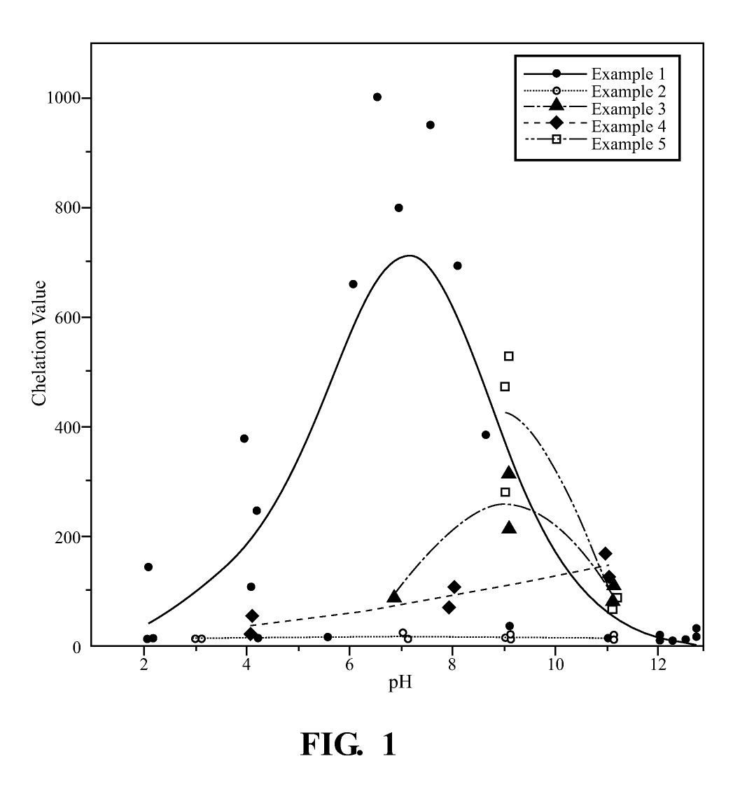

FIG. 1 is a graph showing the relationship between the measured chelation value and the pH of the chelating agents tested, and FIG. 1 is generated from the data set forth in Table 1 above. As shown in FIG. 1, the chelating agent of Example 1 (i.e., the chelating agent that includes the poly-2-ethyl-2-oxazoline having a weight average molecular weight of about 14,000) has a measured chelation value of about 725 mg of CaCO₃/g of chelating agent at a pH of about 7. Further, the measured chelation value of the chelating agent of Example 1 is at least 500 mg of CaCO₃/g of chelating agent at a pH of from about 6 to about 8. Thus, chelating agent of Example 1 is suitable as a chelating agent at neutral, slightly acidic, or slightly basic pHs.

In contrast to Example 1, none of the comparative chelating agents (i.e., Examples 2 through 5) exhibit a chelation value over 200 of CaCO₃/g of chelating agent at a pH of from about 6 to about 8. The polyoxazoline of Example 2 does not have a measured chelation value, rendering this polyoxazoline as being unsuitable as a chelating agent. Further, the chelating agents including Examples 3 and 5 show some chelating ability at a pH higher than 8. For instance, the chelating agent of Example 5 has a measured chelation value of about 425 mg of CaCO₃/g of chelating agent at a pH of about 9. Further, the chelating agent of Example 3 has a measured chelation value of about 100 mg of CaCO₃/g of chelating agent at a pH of about 9. At a pH of about 7, the chelating agent of Example 3 is less than 300 mg of CaCO₃/g of chelating agent. From the data, at a pH of from 6 to 8, the chelating agent including poly-2-ethyl-2-oxazoline (Example 1) is the best option.

As used herein, the term “about” is understood by persons of ordinary skill in the art and varies to some extent depending upon the context in which the term is used. If there are uses of the term which are not clear to persons of ordinary skill in the art, given the context in which the term is used, “about” means up to plus or minus 10% of the particular term.

It is to be understood that one or more of the values described above may vary by ±5%, ±10%, ±15%, ±20%, ±25%, ±30%, etc. so long as the variance remains within the scope of the invention. It is also to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The subject matter of all combinations of independent and dependent claims, both singly and multiply dependent, is herein expressly contemplated but is not described in detail for the sake of brevity. The invention has been described in an illustrative manner, and it is to be understood that the terminology which has been used is intended to be in the nature of words of description rather than of limitation. Many modifications and variations of the present invention are possible in light of the above teachings, and the invention may be practiced otherwise than as specifically described.

1. A chelating agent comprising:
a polyoxazoline having formula A: 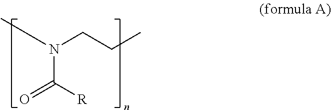
wherein R is H; F; Cl; Br; I; CN; NO₂; an organic group having from 1 to 20 carbon atoms; an amino group; or an oxazoline, and n is from about 2 to about 300, the polyoxazoline having a weight average molecular weight of from about 1,500 to about 30,000.

2. The chelating agent as defined in claim 1 further comprising water.

3. The chelating agent as defined in claim 2, wherein the polyoxazoline is present in the chelating agent in an amount of from about 35 to about 45 wt %, and the water is present in the chelating agent in an amount of from about 55 to about 65 wt %, both based on the total wt % of the chelating agent.

4. The chelating agent as defined in claim 1, wherein the polyoxazoline has a chelation value of from about 300 to 800 mg of CaCO₃/g of chelating agent at a pH of the chelating agent of from about 6 to about 8, the chelation value measured according to the AATCC Test Method 149-2012.

5. The chelating agent as defined in claim 1, wherein the polyoxazoline is poly-2-ethyl-2-oxazoline.

6. The chelating agent as defined in claim 1, wherein the polyoxazoline bonds to a metal ion at a pH of the chelating agent of from about 6 to about 8, and wherein the polyoxazoline releases the metal ion at a pH of the chelating agent below 6.

7. A method of making the chelating agent of claim 1, the method comprising:
preparing the polyoxazoline; and
mixing the polyoxazoline with water.

8. The method as defined in claim 7, wherein the preparing of the polyoxazoline comprises continuously polymerizing an oxazoline monomer in a reactor at an elevated temperature.

9. The method as defined in claim 8, wherein the continuously polymerizing of the oxazoline monomer comprises:
feeding continuously the oxazoline monomer and a catalyst to the reactor at a rate that provides for a residence time sufficient to achieve ring opening of the oxazoline monomer to polymerize the oxazoline monomer, wherein the reactor is maintained at a temperature from about 150° C. to about 250° C.; and
exiting a polyoxazoline solution from the reactor, the polyoxazoline solution comprising the catalyst or catalyst fragments and, optionally, unreacted oxazoline monomer, oligomeric species of the oxazoline monomer, or a mixture thereof.

10. The method as defined in claim 8, wherein the oxazoline monomer is a compound having formula C: 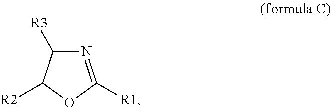
wherein R1, R2, and R3 are individually H; F; Cl; Br; I; CN; NO₂; an organic group having from 1 to 20 carbon atoms; an amino group; or an oxazoline.

11. The method as defined in claim 9 further comprising recovering the polyoxazoline from the polyoxazoline solution, wherein a yield of the polyoxazoline is greater than 90%.

12. A chelating agent formed by a method comprising:
continuously polymerizing an oxazoline monomer in a reactor at an elevated temperature to form a polyoxazoline having formula A: 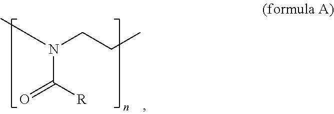
wherein R is H; F; Cl; Br; I; CN; NO₂; an organic group having from 1 to 20 carbon atoms; an amino group; or an oxazoline, and n is from about 2 to about 300, the polyoxazoline having a weight average molecular weight of from about 1,500 to about 30,000; and
mixing the polyoxazoline with water.

13. A method of deactivating a metal ion, the method comprising:
continuously polymerizing an oxazoline monomer in a reactor at an elevated temperature to form a polyoxazoline having formula A: 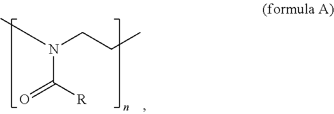
wherein R is H; F; Cl; Br; I; CN; NO₂; an organic group having from 1 to 20 carbon atoms; an amino group; or an oxazoline, and n is from about 2 to about 300, the polyoxazoline having a weight average molecular weight of from about 1,500 to about 30,000; and
introducing the polyoxazoline into a system including the metal ion, wherein the polyoxazoline complexes with and deactivates the metal ion.

14. The method as defined in claim 13 further comprising mixing the polyoxazoline with water to form a chelating agent prior to introducing the polyoxazoline into the system.

15. The method as defined in claim 14 further comprising:
combining the chelating agent with a composition; and
incorporating the composition into the system.

16. The method as defined in claim 14 further comprising adjusting a pH of the chelating agent to a pH of from about 6 to about 8.
